(19) United States
(12) Patent Application Publication
(10) Pub. No.: US 2006/0210688 A1
(43) Pub. Date: Sep. 21, 2006

(54) DEHYDRATED SPORTS DRINK POWDER

(76) Inventor: Thomas E. Mower, Payson, UT (US)

Correspondence Address: STARKWEATHER & ASSOCIATES, 9035 SOUTH 1300 EAST, SUITE 200, SANDY, UT, 84094, US

(21) Appl. No.: 11/307,033

(22) Filed: Jan. 19, 2006

Related U.S. Application Data
(63) Continuation-in-part of application No. 11/083,826, filed on Mar. 18, 2005.

(51) Int. Cl. A23L 2/00

(52) U.S. Cl. 426/590

(57) ABSTRACT

A dehydrated sports drink powder, comprising a solution of partially hydrolyzed fucoidan, a carbohydrate, and an electrolyte. According to another embodiment is a sports drink which includes a solution of the dehydrated sports drink powder and water.

This application is a Continuation-in-Part of, and claims the benefit of application Ser. No. 11/083,826, filed on 18 Mar. 2005, by Thomas E. Mower, entitled Fucoidan Compositions and Methods for Dietary and Nutritional Supplements, the entirety of which is herein incorporated by reference.

### BACKGROUND OF THE INVENTION

1. Field of the Invention

The present invention relates to dehydrated sports drink powder, specifically drinks containing partially hydrolyzed fucoidan.

2. Description of the Related Art

Sports drinks, rehydration drinks, energy drinks, nutrient drinks, and activity drinks have been developed to assist with the losses of various compounds during physical activity. These terms are equivalent when used herein. Typically, sports drinks have been developed to replace sugars, electrolytes, vitamins, minerals, amino acids, proteins, and other important nutrients. Physical activity includes not only exercise and sports by healthy individuals, but may also include any activity where important nutrients are lost, such as work by factory or farm workers, activity by chronically ill patients, living in harsh conditions such as in the tropics or in the desert, and so forth.

There are a number of symptoms of heat exhaustion that may develop as a result of loss of water due to sweat. These symptoms include, for example, vertigo/dizziness, lightheadedness, fatigue and muscle cramps. Most of the symptoms are obvious to the individual, but sometimes lightheadedness is not, because a lightheaded individual is unable to think or act appropriately.

Following exercise, replenishing the lost water and the lost nutrients has been the goal of at least two decades of sports drink research. For example, U.S. Pat. No. 6,051,236 to Portman states that nutritional intervention to achieve maximum muscle recovery has been primarily directed toward restoration of fluid and electrolytes or the replenishment of muscle glycogen stores. This patent also points out that muscle recovery depends on four major factors, namely, restoration of fluid and electrolytes, replenishment of muscle glycogen, reduction of oxidative and muscle stress, and rebuilding and repair of muscle protein damaged.

Typically marketed sports drinks contain sugars and electrolytes. Some examples of the sugars contained in the sports drinks include sucrose, glucose, fructose and so forth. Typical electrolytes include sodium salts, potassium salts, chloride salts, and so forth. Some sports drinks also contain other nutrients. For example, U.S. Pat. No. 3,697,287 to Winitz discloses a composition with all of the amino acids.

The replenishment of muscle glycogen requires that the carbohydrate source be composed of primarily low glycemic index sugars such as arabinose, ribose, xylose, fructose, levulose, psicose, sorbose, tagose, and sorbitol. Also, the body should be stimulated to the production of insulin. Insulin is a hormone responsible for the transport of glucose into the muscle cell where it becomes a substrate for the synthesis of glycogen, as well as for the stimulation of the enzyme, glycogen synthetase. Further, maximization of glycogen replenishment depends on the timing of the carbohydrate replenishment. The enzyme responsible for converting glucose into glycogen, glycogen synthetase, is maximally stimulated up to 2 hours post exercise.

In another example, U.S. Pat. No. 6,051,236, Portman discloses that addition of protein and arginine to a carbohydrate mixture stimulates insulin release, thereby facilitating glucose transport into the muscle cell and stimulating glycogen synthesis. Protein also provides another benefit in the post exercise recovery process by rebuilding muscle cells damaged during exercise.

Fucoidan is a sulfated polysaccharide found in many sea plants and animals, and is particularly concentrated in the cell walls of brown algae (Phaeophyceae). Fucoidan is a complex carbohydrate polymer composed mostly of sulfated L-fucose residues. These polysaccharides are easily extracted from the cell wall of brown algae with hot water or dilute acid and may account for more than 40% of the dry weight of isolated cell walls. O. Berteau & B. Mulloy, Sulfated Fucans, Fresh Perspectives: Structures, Functions, and Biological Properties of Sulfated Fucans and an Overview of Enzymes Active Toward this Class of Polysaccharide, 13 Glycobiology 29R-40R (2003). Fucoidan structure appears to be linked to algal species, but there is insufficient evidence to establish any systematic correspondence between structure and algal order. High amounts of α (1-3) and α (1-4) glycosidic bonds occur in fucoidans from Ascophyllum nodosum. A disaccharide repeating unit of alternating α (1-3) and α (1-4) bonds represents the most abundant structural feature of fucoidans from both A. nodosum and Fucus vesiculosus which are species of seaweed. Sulfate residues are found mainly in position 4. Further heterogeneity is added by the presence of acetyl groups coupled to oxygen atoms and branches, which are present in all the plant fucoidans. Following is a representation of A. nodosum fucoidan:

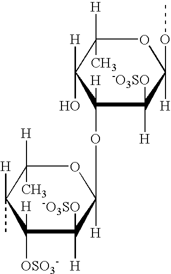

Fucoidan-containing seaweeds have been eaten and used medicinally for at least 3000 years in Tonga and at least 2000 years in China. An enormous amount of research has been reported in the modern scientific literature, where more than 500 studies are referenced in a PubMed search for fucoidan.

The physiological properties of fucoidans in the algae appear to be a role in cell wall organization and possibly in cross-linking of alginate and cellulose and morphogenesis of algal embryos. Fucoidans also have a wide spectrum of activity in biological systems. They have anticoagulant and antithrombotic activity, act on the inflammation and immune systems, have antiproliferative and antiadhesive effects on cells, and have been found to protect cells from viral infection.

Further, fucoidans have numerous beneficial functions that heal and strengthen different systems of the body, including anti-viral, anti-inflammatory, anti-coagulant, and anti-tumor properties. A. I. Usov et al., Polysaccharides of Algae: Polysaccharide Composition of Several Brown Algae from Kamchatka, 27 Russian j. Bio. Chem. 395-399 (2001). Fucoidan has been found to build and stimulate the immune system. Research has also indicated that fucoidan reduces allergies, inhibits blood clotting, fights diabetes by controlling blood sugar, prevents ulcers, relieves stomach disorders, reduces inflammation, protects the kidneys by increasing renal blood flow, and detoxifies the body. Fucoidan also helps to reduce and prevent cardiovascular disease by lowering high cholesterol levels and activating enzymes involved in the beta-oxidation of fatty acids.

A Japanese study found that fucoidans enhanced phagocytosis, the process in which white blood cells engulf, kill, digest, and eliminate debris, viruses, and bacteria. An American study reported that fucoidans increased the number of circulating mature white blood cells. An Argentine study and a Japanese study found that fucoidans inhibited viruses, such as herpes simplex type I, from attaching to, penetrating, and replicating in host cells. A Swedish study is among the many that showed fucoidans inhibit inflammation cascades and tissue damage that may lead to allergies. Other studies, such as one in Canada, found that fucoidans block the complement activation process that is believed to play an adverse role in chronic degenerative diseases, such as atherosclerosis, heart attack, and Alzheimer's disease. Two American studies found that fucoidans increase and mobilize stem cells.

Researchers have also determined that fucoidan tends to combat cancer by reducing angiogenesis (blood vessel growth), inhibiting metastasis (spreading of cancer cells to other parts of the body), and promoting death of cancer cells. Certain societies that make brown seaweed part of their diet appear to have remarkably low instances of cancer. For example, the prefecture of Okinawa, where the inhabitants enjoy some of the highest life expectancies in Japan, also happens to have one of the highest per capita consumption rates of fucoidans. It is noteworthy that the cancer death rate in Okinawa is the lowest of all the prefectures in Japan.

Brown seaweed, a ready source of fucoidan, is found in abundance in various ocean areas of the world. One of the purest locations that provides some of the highest yields of fucoidan is in the clear waters surrounding the Tongan islands, where the seaweed is called limu moui. In Japan, hoku kombu (Laminaria japonica), is said to be particularly rich in fucoidans and is similar to limu moui. The Japanese also consume at least two other types of brown seaweed-wakame and mozuku (Cladosiphon and Nemacystus).

Typically, about four percent by weight of Tongan limu moui is fucoidan. There are at least three types of fucoidan polymer molecules found in brown seaweed. U-fucoidan, having about 20 percent glucuronic acid, is particularly active in carrying out cancer cell destruction. F-fucoidan, a polymer of mostly sulfated fucose, and G-fucoidan both tend to induce the production of HGF cells that assist in restoring and repairing damaged cells. All three types of fucoidan also tend to induce the production of agents that strengthen the immune system.

What is needed is a sports drink in concentrate form that solves one or more of the problems described herein and/or one or more problems that may come to the attention of one skilled in the art upon becoming familiar with this specification. One of such problems is a sports drink include assisting in anti0aging, regeneration of cells and tissues such as muscles and/or bones, promoting growth factors, promoting vitality and youthfulness, strengthening the immune system, reducing allergies, inhibiting blood clotting, controlling blood sugar, preventing ulcers, reliving stomach disorders, reducing inflammation, protecting the kidneys, lowering cholesterol levels, inhibiting smooth muscle cell proliferation, activating enzymes involved in the beta-oxidation of fatty acids and/or detoxifying the body.

### SUMMARY OF THE INVENTION

The present invention has been developed in response to the present state of the art, and in particular, in response to the problems and needs in the art that have not yet been fully solved by currently available sports drinks in concentrate form. According to one embodiment, the present invention has been developed to provide a dehydrated sports drink powder, which includes a partially hydrolyzed fucoidan, a carbohydrate, and an electrolyte.

The partially hydrolyzed fucoidan, carbohydrate and electrolyte may be substantially devoid of water. The partially hydrolyzed fucoidan may be a derivative of one of the group of: Japanese mozuku seaweed, Japanese kombu seaweed, Tongan limu moui seaweed, and combinations thereof. The partially hydrolyzed fucoidan may be Tongan limu moui seaweed. The partially hydrolyzed fucoidan may be sulfonated. The carbohydrate may be one of the group consisting of: glucose, glucose polymers, dextrose, maltose, maltodextrin, maltrotiose, lactose, galactose, sucrose, sucanat, arabinose, ribose, xylose, fructose, levulose, psicose, sorbose, tagatose, sorbitol, and combinations thereof. The electrolyte may be one of the group consisting of: chloride salts, bromide salts, sodium salts, potassium salts, magnesium salts, calcium salts, citrate salts, acetate salts, phosphate salts, salicylates, bicarbonate salts, lactate salts, sulphate salts, tartrate salts, benzoate salts, selenite salts, molybdate salts, iodide salts, oxides, and combinations thereof.

The dehydrated sports drink powder may further include a protein. The protein may be one selected from the group consisting of: calcium caseinate, whey protein, whey protein isolate, soy protein, casein hydrolyzate, meat protein, yeast concentrate, and combinations thereof.

The dehydrated sports drink powder may further include a preservative. The preservative may be sodium benzoate.

The dehydrated sports drink powder may further include a derivative of a nutraceutical ingredient having a high ORAC value. The nutraceutical ingredient having a high ORAC value may be a member selected from the group consisting of grape concentrate, blueberry concentrate, acai fruit concentrate, raspberry concentrate, blackberry concentrate, strawberry concentrate, plum concentrate, orange concentrate, cherry concentrate, kiwi fruit concentrate, currant concentrate, elderberry concentrate, black currant concentrate, cranberry concentrate, mangosteen, noni, aronia, wolfberry, anthocyanidins, curcuminoids, and mixtures thereof.

The dehydrated sports drink powder may, further comprise minerals. The mineral may be a deep sea mineral.

The dehydrated sports drink powder may further include an amino acid.

According to another embodiment, the present invention includes a sports drink comprising a solution of the dehydrated sports drink powder, and water.

The sports drink of claim 17, wherein the carbohydrate comprises from about 0.4 weight percent to about 45 weight percent of the solution.

The solution may include from about 0.001 weight percent to about 1 weight percent electrolyte. The solution may include from about 0.05 to about 95 weight partially hydrolyzed fucoidan.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

As used herein, “comprising,” “including,” “containing,” “is,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “partially hydrolyzed fucoidan” means fucoidan that has been hydrolyzed into smaller polymers and oligomers, but not so thoroughly hydrolyzed as to result in complete hydrolysis to substantially primarily monosaccharides.

As used herein, “high ORAC value” or similar terms means an ORAC value of at least about 400 per 100 grams of fruit or vegetable. For example, blueberries have an ORAC value of about 2,400 per 100 grams, and the following fruits have ORAC values as shown in parentheses per 100 grams: blackberries (2,036), cranberries (1,750), strawberries (1,540), raspberries (1,220), plums (949), oranges (750), red grapes (739) cherries (670), kiwi fruit (602), and white grapes (446). Other fruits known to have a high ORAC value include black grapes, mangosteen, noni, aronia, wolfberry, and acai, and the like. Further, nutraceutical ingredients known to have high ORAC values include proanthocyanidins, such as from extracts of grape seed and bark of white pine of southern Europe (e.g., pycnogenol, U.S. Pat. No. 4,698,360), and curcuminoids. Oligomeric proanthocyanidins (OPC) are illustrative.

As used herein, “sterilizing” and similar terms means, with respect to nutritional supplements having a pH less than 4.6 and a water activity greater than 0.85, pasteurizing the nutritional supplement and storing at room temperature. With respect to nutritional supplements having a pH greater than 4.6 and a water activity greater than 0.85, “sterilizing” and similar terms mean applying heat such that the nutritional supplement is rendered free of microorganisms capable of reproducing in the nutritional supplement under normal non-refrigerated conditions of storage and distribution.

As used herein, “pasteurization” means a process named after scientist Louis Pasteur to destroy harmful bacteria that may be present without substantially affecting flavor and food value. For example, one pasteurization process includes heating every particle of milk to not lower than 62.8° C. (i.e., 145° F.) for not less than 30 minutes and promptly cooling the milk. Currently, the most common method of pasteurization in the United States is High Temperature Short Time (HTST) pasteurization, which uses metal plates and hot water to raise temperatures to 71.7° C. (i.e., 161° F.) for not less than 15 seconds, followed by rapid cooling. Ultra Pasteurization (UP) is a process similar to HTST pasteurization, but using higher temperatures and longer times. UP pasteurization results in a product with longer shelf life but still requiring refrigeration of milk, but not of acidified foods or nutritional supplements (pH<4.6). Another method, Ultra High Temperature (UHT) pasteurization, raises the temperature to over 93.3° C. (i.e., 200° F.) for a few seconds, followed by rapid cooling. A UHT-pasteurized product that is packaged aseptically results in a “shelf stable” product that does not require refrigeration until it is opened.

As used herein, “aseptic processing and packaging” and similar terms mean the filling of a sterilized cooled product into pre-sterilized containers, followed by aseptic hermetic sealing, with a pre-sterilized closure, in an atmosphere free of microorganisms.

As used herein, “hermetically sealed container” and similar terms mean a container that is designed and intended to be secure against the entry of microorganisms and thereby to maintain the sterility of its contents after processing.

As used herein, “coloring agents” are agents that give tablets a more pleasing appearance, and in addition help the manufacturer to control the product during its preparation and help the user to identify the product. Any of the approved certified water-soluble FD&C dyes, mixtures thereof, or their corresponding lakes may be used to color tablets. A color lake is the combination by adsorption of a water-soluble dye to a hydrous oxide of a heavy metal, resulting in an insoluble form of the dye.

As used herein, “flavoring agents” vary considerably in their chemical structure, ranging from simple esters, alcohols, and aldehydes to carbohydrates and complex volatile oils. Natural and synthetic flavors of almost any desired type are now available.

The present invention advances prior art dietary supplements by providing a dietary supplement formulated with fucoidan from seaweed, such as limu moui, kombu, or mozuku. The addition of fucoidan to the dietary supplement of the present invention serves to provide significant dietary and nutritional advantages not found in prior art dietary supplements. The fucoidan-enhanced dietary supplement of the present invention provides many beneficial functions, including providing for life extension, anti-aging, and regeneration of cells and tissues, such as muscles and bones; promoting growth factors in the body; promoting high energy, vitality, and youthfulness; maintaining and strengthening the immune system, reducing allergies, inhibiting blood clotting, controlling blood sugar, preventing ulcers, reliving stomach disorders, reducing inflammation, protecting the kidneys, and detoxifying the body. Fucoidan preparations according to the present invention may also help to reduce and prevent cardiovascular disease by lowing cholesterol levels, inhibiting smooth muscle cell proliferation, and activating enzymes involved in the beta-oxidation of fatty acids.

In addition, the fucoidan-enhanced dietary supplement of the present invention fights cancerous tumors and minimizes the visible signs of both biological and environmental aging. That is, the present dietary supplements slow the aging process, assist in regenerating damaged cells and tissues, and promote growth factors in the body. Fucoidan is high in antioxidants that help to fight free radical damage to the body that may lead to cancer. Fucoidan also provides significant benefits to the skin. Fucoidan is high in antioxidants that help to fight free radical damage caused by the sun and other changing environmental conditions and elements.

Brown seaweed, a source of fucoidan, grows in many oceans, including off the coasts of Japan and Okinawa, Russian coastal waters, Tonga, and other places. An excellent source of fucoidan is the limu moui sea plant growing in the waters of the Tongan islands. This brown seaweed contains many vitamins, minerals, and other beneficial substances and is particularly rich in fucoidan.

Typically, the brown seaweed grows in long angel hair stems with numerous leaves. The fucoidan ingredient is found in natural compositions on the cell walls of the seaweed, providing a slippery sticky texture that protects the cell walls from the sunlight.

In one embodiment, a kombu-type or mozuku-type seaweed is harvested from the coastal waters of the Tongan islands. These seaweeds can be manually harvested, including stems and leaves, by divers and cleaned to remove extraneous materials. The seaweed is then usually frozen in large containers and shipped to a processing plant.

In processing, the heavy outer fibers must first be broken down to provide access to the fucoidan component. If frozen, the seaweed material is first thawed, but if not frozen, then the seaweed material is placed in a mixing vat and shredded, while being hydrolyzed with acids and water. The material can optionally be sulfonated with sulfuric acid to help in breaking down the heavy cell fibers. The mixture is also buffered with citric acid and thoroughly blended to maintain suspension. The material may also be heated at atmospheric or greater than atmospheric pressure while mixing. The resulting puree is tested and maintained at a pH of about 2 to 4 so as to remain acidic, thus enhancing preservative and stability characteristics.

The puree may be used in preparing dietary supplement products. Alternately, the mixture may be refrozen in small containers for later processing.

According to one embodiment, the present invention provides a dehydrated sports drink powder formulated with fucoidan compositions from seaweed, such as the limu moui seaweed plant. In another embodiment, the fucoidan compositions are present in selected embodiments from about 0.5 to about 70 percent by weight of the total weight of the composition. In yet another embodiment, other components may include an antioxidant, such as acai fruit and blueberry having a high oxygen radical absorbance capacity (ORAC). In still another embodiment, such antioxidants may be present in amounts from about 0.001 to about 20 percent by weight. In additional embodiment, minerals such as deep sea minerals may be present in an amount from about 0.001 to about 2 percent by weight, to provide important minerals.

In a further embodiment, the partially hydrolyzed fucoidan may be derived from Tongan limu moui, Japanese hoku kombu (Laminaria japonica), wakame, or mozuku (Cladosiphon and Nemacystus). In still a further embodiment, the partially hydrolyzed fucoidan may be sulfonated.

High ORAC Nutraceutical Ingredients

Free radicals are very reactive and highly destructive compounds in the body. Free radicals are products of oxidative deterioration of such substances as polyunsaturated fat. Antioxidants convert free radical into a less reactive and nonharmful chemical form. Antioxidants that can be used in dietary supplements include β-carotene, vitamin E, vitamin C, N-acetyl cysteine, α-lipoic acid, selenium, and the like. Antioxidants having a high ORAC value are particularly desirable. Illustratively, nutraceutical antioxidants of high ORAC value that can be used in the present invention include concentrates of grape (red, black, or white), blueberry, acai fruit, raspberry, blackberry, strawberry, plum, orange, cherry, kiwi fruit, currant, elderberry, black currant, cranberry, mangosteen, noni, aronia, wolfberry, and mixtures thereof. Other high ORAC nutraceutical ingredients include proanthocyanidins, such as oligomeric proanthocyanidins, curcuminoids, and the like.

Minerals

Minerals serve a wide variety of essential physiological functions ranging from structural components of body tissues to essential components of many enzymes and other biological important molecules. Minerals are classified as micronutrients or trace elements on the basis of the amount present in the body. The seven micronutrients (calcium, potassium, sodium, magnesium, phosphorus, sulfur, and chloride) are present in the body in quantities of more than five grams. Trace elements, which include boron, copper, iron, manganese, selenium, and zinc are found in the body in quantities of less than five grams.

Micronutrient Minerals. Calcium is the mineral element believed to be most deficient in the diet in the United States. Calcium intakes in excess of 300 mg per day are difficult to achieve in the absence of milk and dairy products in the diet. This is far below the recommended dietary allowance (RDA) for calcium (1000 mg per day for adults and children ages one to ten, 1200 mg per day for adolescents and pregnant and lactating women, which equates to about four glasses of milk per day). In fact, it has been reported that the mean daily calcium intake for females over age 12 does not exceed 85 percent of the RDA. In addition, during the years of peak bone mass development (18 to 30), more than 66 percent of all U.S. women fail to consume the recommended amounts of calcium on any given day. After age 35, this percentage increases to over 75 percent.

Although the general public is not fully aware of the consequences of inadequate mineral intake over prolonged periods of time, there is considerable scientific evidence that low calcium intake is one of several contributing factors leading to osteoporosis. In addition, the dietary ratio of calcium to phosphorous (Ca:P) relates directly to bone health. A Ca to P ratio of 1:1 to 2:1 is recommended to enhance bone marrowization in humans. Such ratios are difficult to achieve absent an adequate dietary supply of milk and dairy products, or an adequate supply of calcium and other minerals for the lactose-intolerant segment of the population.

Magnesium is the second most plentiful cation of the intracellular fluids. It is essential for the activity of many enzyme systems and plays an important role with regard to neurochemical transmission and muscular excitability. Deficits are accompanied by a variety of structural and functional disturbances. The average 70-kg adult has about 2000 mEq of magnesium in his body. About 50% of this magnesium is found in bone, 45% exists as an intracellular cation, and 5% is in the extracellular fluid. About 30% of the magnesium in the skeleton represents an exchangeable pool present either within the hydration shell or on the crystal surface. Mobilization of the cation from this pool in bone is fairly rapid in children, but not in adults. The larger fraction of magnesium in bone is apparently an integral part of bone crystal.

The average adult in the United States ingests about 20 to 40 mEq of magnesium per day in an ordinary diet, and of this about one third is absorbed from the gastrointestinal tract. The evidence suggests that the bulk of the absorption occurs in the upper small bowel. Absorption is by means of an active process apparently closely related to the transport system for calcium. Ingestion of low amounts of magnesium results in increased absorption of calcium and vice versa.

Magnesium is a cofactor of all enzymes involved in phosphate transfer reactions that utilize adenosine triphosphate (ATP) and other nucleotide triphosphates as substrates. Various phosphatases and pyrophosphatases also represent enzymes from an enormous list that are influenced by this metallic ion.

Magnesium plays a vital role in the reversible association of intracellular particles and in the binding of macromolecules to subcellular organelles. For example, the binding of messenger RNA (mRNA) to ribosomes is magnesium dependent, as is the functional integrity of ribosomal subunits. Certain of the effects of magnesium on the nervous system are similar to those of calcium. An increased concentration of magnesium in the extracellular fluid causes depression of the central nervous system (CNS). Hypomagnesemia causes increased CNS irritability, disorientation, and convulsions. Magnesium also has a direct depressant effect on skeletal muscle. Abnormally low concentrations of magnesium in the extracellular fluid result in increased acetylcholine release and increased muscle excitability that can produce tetany.

Trace Elements. Boron is required by the body in trace amounts for proper metabolism of calcium, magnesium, and phosphorus. Boron helps brain function, healthy bones, and can increase alertness. Boron is also useful for people who want to build muscle. Boron is known to help prevent postmenopausal osteoporosis. Further, a relationship has been shown between a lack of boron in the diet and the chances of developing arthritis. R. E. Newnham, 46 Journal of Applied Nutrition (1994).

Chromium is an important trace element wherein the lack of sufficient chromium in the diet leads to impairment of glucose utilization, however, disturbances in protein and lipid metabolism have also been observed. Impaired glucose utilization occurs in many middle-aged and elderly human beings. In experimental studies, significant numbers of such persons have shown improvement in their glucose utilization after treatment with chromium. Chromium is transported by transferrin in the plasma and competes with iron for binding sites. Chromium as a dietary supplement may produce benefits due to its enhancement of glucose utilization and its possible facilitating the binding of insulin to insulin receptors, which increases its effects on carbohydrate and lipid metabolism. Chromium as a supplement may produce benefits in atherosclerosis, diabetes, rheumatism, and weight control.

Copper is another important trace element in the diet. The most common defect observed in copper-deficient animals is anemia. Other abnormalities include growth depression, skeletal defects, demyelination and degeneration of the nervous system, ataxia, defects in pigmentation and structure of hair or wool, reproductive failure and cardiovascular lesions, including dissecting aneurisms. Several copper-containing metalloproteins have been isolated, including tyrosinase, ascorbic acid oxidase, laccase, cytochrome oxidase, uricase, monoamine oxidase, δ-aminolevulinic acid hydrydase, and dopamine-β-hydroxylase. Copper functions in the absorption and utilization of iron, electron transport, connective tissue metabolism, phospholipid formation, purine metabolism, and development of the nervous system. Ferroxidase I (ceruloplasmin), a copper-containing enzyme, effects the oxidation of Fe(II) to Fe(III), a required step for mobilization of stored iron. A copper-containing enzyme is thought to be responsible for the oxidative deamination of the epsilon amino group of lysine to produce desmosine and isodesmosine, the cross-links of elastin. In copper-deficient animals the arterial elastin is weaker and dissecting aneurisms may occur.

Iodine is important for the production of thyroid hormones, which regulate cellular oxidation. The iodine-deficiency disease is goiter. In iodine-deficient young, growth is depressed and sexual development is delayed, the skin and hair are typically rough, and the hair becomes thin. Cretinism, feeble-mindedness, and deaf-mutism occur in a severe deficiency. There is reproductive failure in females and decreased fertility in males that lack sufficient iodine in the diet.

Iron is an essential component of several important metalloproteins. These include hemoglobin, myoglobin, and many oxidation-reduction enzymes. In iron deficiency, there may be reduced concentrations of some of the iron-containing enzymes, such as cytochrome c in liver, kidney, and skeletal muscle, and succinic dehydrogenase in the kidney and heart.

Manganese plays a role in the synthesis of GAGs, collagen, and glycoproteins, which are important constituents of cartilage and bone. Manganese is required for enzyme activity of glycosyltransferases. This family of enzymes is responsible for linking sugars together into GAGs, adding sugars to other glycoproteins, adding sulfate to aminosugars, converting sugars to other modified sugars, and adding sugars to lipids. These functions are manifested as GAG synthesis (hyaluronic acid, chondroitin sulfate, karatan sulfate, heparin sulfate, and dermatin sulfate, among others), collagen synthesis, and function of many other glycoproteins and glycolipids. GAGs and collagen are chief structural elements for all connective tissues. Their synthesis is essential for proper maintenance and repair of connective tissues.

Manganese deficiencies in humans and animals lead to abnormal bone growth, swollen and enlarged joints, and slipped tendons. In humans, manganese deficiencies are associated with bone loss, arthritis, and impaired glucose utilization. Levels of all GAGs are decreased in connective tissues during manganese deficiencies, with chondroitin sulfates being most depleted. Manganese-deficient organisms quickly normalize GAG and collagen synthesis when manganese is provided.

Manganese is also required for activity of manganese superoxide dismutase (MnSOD), which is present only in mitochondria. Manganese deficiency decreases the activity of MnSOD and may lead to mitochondrial dysfunction, manifested as decreased cellular functions. Manganese is required for the conversion of mevalonic acid to squalene. Pyruvate carboxylase is a manganese metalloenzyme, repressible by insulin, important in the citric acid cycle for the oxidation of carbohydrates, lipids, and proteins, as well as in the synthesis of glucose and lipids.

Molybdenum is an essential mineral found in highest concentrations in the liver, kidneys, skin, and bones. This mineral is required by the body to properly metabolize nitrogen. It is also a vital component of the enzyme xanthine oxidase, which is required to convert purines to uric acid, a normal byproduct of metabolism. Molybdenum also supports the body's storage of iron and other cellular functions such as growth. A deficiency of molybdenum is associated with mouth and gum disorders and cancer. A diet high in refined and processed foods can lead to a deficiency of molybdenum, resulting in anemia, loss of appetite and weight, and stunted growth in animals. While these deficiencies have not been observed directly in humans, it is known that a molybdenum deficiency can lead to impotence in older males.

Selenium is an essential trace element that functions as a component of enzymes involved in protection against antioxidants and thyroid hormone metabolism. In several intra- and extra-cellular glutathione peroxidases and iodothyronine 5′-deiodinases, selenium is located at the active centers as the selenoamino acid, selenocysteine (SeCYS). At least two other proteins of unknown function also contain SeCYS. Although SeCYS is an important dietary form, it is not directly incorporated into these specific selenium-proteins; instead, a co-translational process yields tRNA-bound SeCYS. In contrast, selenium as seleno-methionine is incorporated non-specifically into many proteins, as it competes with methionine in general protein synthesis. Therefore, tissues often contain both specific, as well as the nonspecific, selenium-containing proteins when both SeCYS and selenomethionine are consumed, as found in many foods. Selenium is a major antioxidant nutrient and is involved in protecting cell membranes and preventing free radical generation, thereby decreasing the risk of cancer and disease of the heart and blood vessels. Medical surveys show that increased selenium intake decreases the risk of breast, colon, lung and prostate cancer. Selenium also preserves tissue elasticity; slows down the aging and hardening of tissues through oxidation; and helps in the treatment and prevention of dandruff. Recent research has shown antitumorigenic effects of high levels of selenium in the diets of several animal models.

Vanadium is an essential nutrient beneficial for thyroid hormone metabolism. The daily requirement necessary to prevent a deficiency is about 10 to 20 micrograms a day. Vanadium deficiency can lead to slow growth, defective bones, and altered lipid metabolism. Vanadium exerts an insulin-like effect in some respects, and there has been a considerable amount of research on vanadium and diabetes. In insulin dependent diabetics, vanadium has been found to reduce the amount of insulin required to manage the disease, and in non-insulin dependent diabetics, vanadium has been known to control the condition altogether. Research has shown that supplementation with vanadium leads to an increase in glucose transport into cells, which suggests that vanadium supplementation of the diet improves glucose metabolism and may aid in preventing diabetes.

Zinc is known to occur in many important metalloenzymes. These include carbonic anhydrase, carboxypeptidases A and B, alcohol dehydrogenase, glutamic dehydrogenase, D-glyceraldehyde-3-phosphate dehydrogenase, lactic dehydrogenase, malic dehydrogenase, alkaline phosphatase, and aldolase. Impaired synthesis of nucleic acids and proteins has been observed in zinc deficiency. There is also evidence that zinc may be involved in the secretion of insulin and in the function of the hormone.

According to the present invention, minerals can be provided as inorganic compounds, such as chlorides, sulfates, and the like. In addition, some minerals can be provided in more bioavailable forms, such as amino acid chelates, which are well known in the art. U.S. Pat. No. 5,292,538. Examples of minerals that can be provided as amino acid chelates include calcium, magnesium, manganese, zinc, iron, boron, copper, molybdenum, and chromium. Still further, minerals can be provided as deep sea minerals.

According to one embodiment of the present invention, the sports drink may include partially hydrolyzed fucoidan, a carbohydrate, an electrolyte, and water. The carbohydrate may be any used in the art of energy and rehydration drinks. Some non-limiting examples of carbohydrates used in energy and rehydration drinks include: glucose, glucose polymers, dextrose, maltose, maltodextrin, maltrotiose, lactose, galactose, sucrose, sucanat, arabinose, ribose, xylose, fructose, levulose, psicose, sorbose, tagatose, sorbitol, and combinations thereof.

When in a drinkable form, the drink may be from about 0.4 weight percent to about 50 weight percent carbohydrate.

The electrolyte of the present invention may include any electrolyte known in the art of sports drinks. Some non-limiting examples of electrolytes include: chloride salts, bromide salts, sodium salts, potassium salts, magnesium salts, calcium salts, citrate salts, acetate salts, phosphate salts, salicylates, bicarbonate salts, lactate salts, sulphate salts, tartrate salts, benzoate salts, selenite salts, molybdate salts, iodide salts, oxides, and combinations thereof.

When in a drinkable form, the drink may be from about 0.001 weight percent to about 2 weight percent electrolyte.

The sports drink of the present invention may also include a protein. Any protein known in the art of energy and rehydration drinks may be used. Some non-limiting examples of proteins used include: calcium caseinate, whey protein, whey protein isolate, soy protein, casein hydrolyzate, meat protein, yeast concentrate, and combinations thereof.

The sports drink of the present invention may also include amino acids. Some non-limiting examples of amino acids that may be included in the sports drink of the present invention include: isoleucine, leucine, methionine, threonine, alanine, glutamic acid, glycine, serine, tyrosine, valine, lysine, phenylalanine, tryptophan, arginine, aspartic acid, histidine, proline, cysteine, and combinations thereof.

According to one embodiment of the present invention, the sports drink is concentrated. The concentrated form may exist in several different forms. For example, the concentrate may be frozen for later dilution with a diluting agent and consumption. In another example, the concentrate is in a syrup form for later dilution with a diluting agent and consumption. Some examples of such concentrates are available from Welch's® (Concord, Mass.) such as Welch's® pourable concentrates and Welch's® frozen concentrates.

The sports drink may be concentrated by any method known in the art. According to one embodiment, all of the components of the sports drink are combined, and then concentrated. According to another embodiment, all of the components of the sports drink except the water are added. Next only enough water was added to dissolve the other constituents. In this embodiment, the solution may then be further concentrated so as to create a supersaturated composition.

After the sports drink is in concentrated form, it may be frozen. Alternatively, the concentrated form may be sterilized and bottled. A diluting agent may then be added to the concentrated form such that the rehydration drink is consumable. The amounts of each constituent given herein refers to the diluted or drinkable form of the sports drink.

The diluting agent may be any known in the art of diluting concentrated drink formulations. Water may be used to dilute the concentrated form to drinkable form. Some other non-limiting examples of diluting agents may include: alcoholic beverages, mineral water, soda water, carbonated water, tonic water, fruit juices, soda drinks, energy drinks, rehydration drinks, sports drinks, and so forth.

In yet another embodiment, the concentrated formulation is in the form of a syrup for use in a fountain drink. The syrup may be formulated as other syrups known in the art. For example, all of the constituents of the sports drink except the water may be combined. Sufficient water may then be added to dissolve the other constituents. This solution may then be further concentrated, for example, by heating, to make a supersaturated syrup. In another example, all of the constituents of the sports drink except the water may be combined. Water, insufficient to completely dissolve the other constituents may then be added. This may then be heated. Upon heating, the constituents become soluble in the water, and form a solution. As the solution cools, a supersaturated solution may be created. In any of the foregoing examples, there may be water insoluble constituents such as fiber, non-polar organic materials, and so forth. These constituents need not be dissolved in either the concentrated or the drinkable form of the sports drink.

In the foregoing fountain drink embodiment, the syrup may then be diluted as in fountain drinks. For example, the syrup may be diluted with water and carbon dioxide in a fountain. Combining and disbursing a drink which includes water, syrup, and carbon dioxide in a fountain is known in the art. Other constituents, syrups, flavors, nutrients, electrolytes, carbohydrates, and so forth may also be added to the sports drink when the constituents are mixed in the fountain with the sports drink. Further, if the drink is available from a fountain that includes various other flavored drinks, the consumer of the drink may be able to choose which other flavors or syrups to add to the sports drink of the present invention.

In yet another embodiment, the sports drink may be formed into a powder form. A powder form may be more convenient to store the energy drink. The energy drink may be dried according to any method known in the art. For example, the sports drink may be spray dried in a spray drier. In another example, the sports drink may be freeze-dried to remove substantially all of the liquid. In one embodiment, all of the constituents of the sports drink except for the carbohydrate is dissolved in the water, and then dried.

In this embodiment, the powder form may then be diluted with a diluting agent as listed above to a drinkable form. According to one embodiment, the powder may be dissolved into a liquid. According to another embodiment, the powder may be dissolved into a boiling liquid. In the embodiment where all of the constituents except for the carbohydrate are dissolved in the water, and then dried, the carbohydrate may be added along with the diluting agent. For example, the carbohydrate may be sugar, brown sugar, corn syrup, molasses, or other commercially available carbohydrates.

Additional elements of the disclosed embodiments may include fruit flavorings and colorings, such as grape and raspberry in small amounts. Sweeteners, such as momordica fruit may also be included. Components to enhance absorption into the body, such as black or Sichuan pepper extracts may be added. Preservatives, such as sodium benzoate or potassium sorbate may also be included. Substantially pure water, such as deionized water, may be also included in the liquid mixture.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A dehydrated sports drink powder, comprising a partially hydrolyzed fucoidan, a carbohydrate, and an electrolyte.

2. The dehydrated sports drink powder of claim 1, being substantially devoid of water.

3. The dehydrated sports drink powder of claim 1, wherein the partially hydrolyzed fucoidan comprises a derivative of one of the group of: Japanese mozuku seaweed, Japanese kombu seaweed, Tongan limu moui seaweed, and combinations thereof.

4. The dehydrated sports drink powder of claim 5, wherein the partially hydrolyzed fucoidan comprises Tongan limu moui seaweed.

5. The dehydrated sports drink powder of claim 1, wherein the partially hydrolyzed fucoidan is sulfonated.

6. The dehydrated sports drink powder of claim 1, wherein the carbohydrate comprises one of the group consisting of: glucose, glucose polymers, dextrose, maltose, maltodextrin, maltrotiose, lactose, galactose, sucrose, sucanat, arabinose, ribose, xylose, fructose, levulose, psicose, sorbose, tagatose, sorbitol, and combinations thereof.

7. The dehydrated sports drink powder of claim 1, wherein the electrolyte comprises one of the group consisting of: chloride salts, bromide salts, sodium salts, potassium salts, magnesium salts, calcium salts, citrate salts, acetate salts, phosphate salts, salicylates, bicarbonate salts, lactate salts, sulphate salts, tartrate salts, benzoate salts, selenite salts, molybdate salts, iodide salts, oxides, and combinations thereof.

8. The dehydrated sports drink powder of claim 1, further comprising a protein.

9. The dehydrated sports drink powder of claim 8, wherein the protein comprises one selected from the group consisting of: calcium caseinate, whey protein, whey protein isolate, soy protein, casein hydrolyzate, meat protein, yeast concentrate, and combinations thereof.

10. The dehydrated sports drink powder of claim 1, further comprising sodium benzoate.

11. The dehydrated sports drink powder of claim 1, further including a derivative of a nutraceutical ingredient having a high ORAC value.

12. The dehydrated sports drink powder of claim 12, wherein the nutraceutical ingredient having a high ORAC value is a member selected from the group consisting of grape concentrate, blueberry concentrate, acai fruit concentrate, raspberry concentrate, blackberry concentrate, strawberry concentrate, plum concentrate, orange concentrate, cherry concentrate, kiwi fruit concentrate, currant concentrate, elderberry concentrate, black currant concentrate, cranberry concentrate, mangosteen, noni, aronia, wolfberry, anthocyanidins, curcuminoids, and mixtures thereof.

13. The dehydrated sports drink powder of claim 1, further comprising a mineral.

14. The dehydrated sports drink powder of claim 14, wherein the mineral comprises a deep sea mineral.

15. The dehydrated sports drink powder of claim 1, further comprising an amino acid.

16. The dehydrated sports deink of claim 16, wherein the amino acid comprises one member of the list consisting of: isoleucine, leucine, methionine, threonine, alanine, glutamic acid, glycine, serine, tyrosine, valine, lysine, phenylalanine, tryptophan, arginine, aspartic acid, histidine, proline, cysteine, and combinations thereof.

17. A sports drink, comprising a solution of the dehydrated sports drink powder of claim 1 and water.

18. The sports drink of claim 17, wherein the carbohydrate comprises from about 0.4 weight percent to about 45 weight percent of the solution.

19. The sports drink of claim 17, wherein the electrolyte comprises from about 0.001 weight percent to about 1 weight percent of the solution.

20. The dehydrated sports drink of claim 17, wherein the partially hydrolyzed fucoidan comprises from about 0.05 to about 95 weight of the solution.
